(19) United States
(12) Patent Application Publication
(10) Pub. No.: US 2008/0143638 A1
(43) Pub. Date: Jun. 19, 2008

(54) THREE DIMENSIONAL IMAGE DISPLAY AND MANUFACTURING METHOD THEREOF

(76) Inventors: Sang-Kyu KIM, Incheon (KR); Sung-Jung LEE, Uwang-si (KR); Min-Jung KIM, Incheon (KR)

Correspondence Address: IPLA P.A., 3580 WILSHIRE BLVD., 17TH FLOOR, LOS ANGELES, CA, 90010, US

(21) Appl. No.: 11/693,997

(22) Filed: Mar. 30, 2007

(30) Foreign Application Priority Data
Dec. 18, 2006 (KR) 10-2006-0129523

(51) Int. Cl. G09G 5/377

(52) U.S. Cl. 345/6

(57) ABSTRACT

A three dimensional image display and a manufacturing method thereof are disclosed, in which a three dimensional image is obtained by using a patterned retarder (so called, phase contrast plate) and a wire grid polarizer. The dimensional image display and manufacturing method thereof can be easily adapted to a LCD of a TFT by using a patterned retarder glass substrate. In addition, the present invention relates to a high quality three dimensional display and a manufacturing method thereof which can easily obtain a three dimensional image by adapting to a display which uses a TFT-LCD, an AMOLED, CNT (Carbon Nano Tube) type wire grid polarizer and other FPDs.

### CROSS REFERENCE

Applicant claims foreign priority under Paris Convention and 35 U.S.C. § 119 to the Korean Patent Application No. 10-2006-0129523, filed Dec. 18, 2006 with the Korean Intellectual Property Office.

### BACKGROUND OF THE INVENTION

1. Field of the Invention

The present invention relates to a three dimensional image display and a manufacturing method thereof, and in particular to a three dimensional image display and a manufacturing method thereof in which a three dimensional image is obtained by using a patterned retarder (so called, phase contrast plate) and a wire grid polarizer. The dimensional image display and manufacturing method thereof can be easily adapted to a LCD of a TFT by using a patterned retarder glass substrate. In addition, the present invention relates to a high quality three dimensional display and a manufacturing method thereof which can easily obtain a three dimensional image by adapting to a display which uses a TFT-LCD, an AMOLED, CNT (Carbon Nano Tube) type wire grid polarizer and other FPDs.

2. Description of the Background Art

Generally, two eyes of a person are spaced apart about 65 mm. When a person sees a certain object, each eye sees slightly different sides of the object. Namely, the shapes of an object when a certain object is seen with one eye being covered with a hand palm and when seen with the other eye being covered with a hand palm are slightly different.

The above differences occur due to a disparity occurring by left and right eyes. The disparity is combined in a brain, so that a person can see a dimensional structure. The above principle is a basic principle that is applied to a production of a three dimensional image.

Here, the three dimensional image technology may be classified into a stereoscopic technique and an auto stereoscopic technique. The stereoscopic technique is implemented using a time difference image of left and right eyes having the most reliable three dimensional effects. The stereoscopic technique is classified into a glasses method and a non-glasses method.

The above three dimensional image technique generally uses an optical phase modulation plate using a liquid crystal. The optical phase modulation plate, which generally uses a liquid crystal, comprises a substrate, an alignment film which is coated on the substrate and is aligned, and a liquid crystal which is coated on the alignment film and is aligned. The liquid crystal is a photo sensitive liquid crystal and is surface-aligned on the alignment film and is bridge-solidified by an optical irradiation such as ultraviolet ray and is made in a form of a polymer liquid crystal film. In addition, the optical axis performs an optical phase modulation function in accordance with an alignment direction of a liquid crystal based on a surface alignment of the alignment layer.

The process problems reside in the technology that a patterned retarder is attached on a front surface or a rear surface (a module of a display is separated, and a patterned retarder is attached) in the process of a conventional three dimensional display. The conventional three dimensional display cannot be directly adapted to a display process. The productivity is low, and process costs are high. When a module is attached or detached, the process is so complicated. Various types of pollutions may be generated.

### SUMMARY OF THE INVENTION

Accordingly, it is an object of the present invention to overcome the above-described problems.

It is another object of the present invention to provide a high quality three dimensional display and a manufacturing method thereof which can implement a three dimensional image by using a patterned retarder and a wire grid polarizer.

It is further another object of the present invention to provider a high quality three dimensional display and a manufacturing method thereof in which it is possible to significantly improve a process problem occurring during an attaching and detaching problem in a conventional manufacture of a three dimensional display and to significantly improve a pollution problem. In addition, the process can be simplified, and the process cost is low, and a higher productivity is obtained. A three dimensional display with a large area can be made in the present invention.

It is still further another object of the present invention to provide a high quality three dimensional image display and a manufacturing method thereof which can be advantageously applied to a display which uses an AMOLED and a CNT type wire grid polarizer and other FPDs and can reliably implement a three dimensional image.

To achieve the above objects, in a three dimensional image display formed of a TFT-LCD, there is provided a three dimensional image display which comprises a patterned retarded on a glass substrate, a layer of protective coating, a wire grid polarizer of a micro pattern having a polarizing function, and a layer of protective coating.

The patterned retarder and wire grid polarizer are formed on a substrate, and the patterned retarder and wire grid polarizer substrate is applied to a color filter substrate of a TFT-LCD.

To achieve the above objects, there is provided a method for manufacturing a three dimensional display which comprises a step in which a substrate having a patterned retarder is used or a patterned retarder is formed on a substrate; a step in which a layer of protective coating is deposited on the patterned retarder substrate; a step in which a formed metallic thin film is etched with a micro wire pattern; a step in which a layer of protective coating is formed on the etched wire pattern; a step in which a color filter is formed; and a cell step in which a substrate having a color filter formed based on a wire grid polarizer process is put together with a substrate having a TFT and the patterned retarder substrate.

### BRIEF DESCRIPTION OF THE DRAWINGS

The present invention will become better understood with reference to the accompanying drawings which are given only by way of illustration and thus are not limitative of the present invention, wherein;

FIG. 1 is a view for describing a principle of a TFT-LCD (Thin Film Transistor Liquid Crystal Display);

FIG. 2 is a view for describing a structure of an OLED and a light emitting principle;

FIG. 3 is a view illustrating a structure according to a first embodiment of the present invention;

FIG. 4 is a view illustrating a structure according to a second embodiment of the present invention;

FIG. 5 is an image illustrating a state that a polarized light is observed by a left eye when a polarizer is used after the polarized light passes a patterned retarder layer;

FIG. 6 is an image illustrating a state that a polarized light is observed by a right eye when a polarizer is used after the polarized light passes a patterned retarder layer;

FIG. 7 is a SEM image illustrating a plane of a patterned wire grid polarizer;

FIG. 8 is a SEM image illustrating a cross section of a patterned wire grid polarizer;

FIG. 9 is a view illustrating a structure that a patterned retarder and a wire grid polarizer are adapted to a color filter (C/F) of a TFT-LCD according to the present invention;

FIG. 10 is a view illustrating a structure of a TFT glass substrate in which a TFT is formed;

FIG. 11 is a view illustrating a state that a light passed through a patterned wire grid polarizer and λ/2 patterned retarder is linearly polarized;

FIG. 12 is a view illustrating a structure according to a third embodiment of the present invention; and

FIG. 13 is a view illustrating a basic structure of a TFT which is used for a TFT-LCD and an AMOLED.

### DETAILED DESCRIPTION OF THE PREFERRED EMBODIMENTS

The preferred embodiments of the present invention will be described with reference to the accompanying drawings.

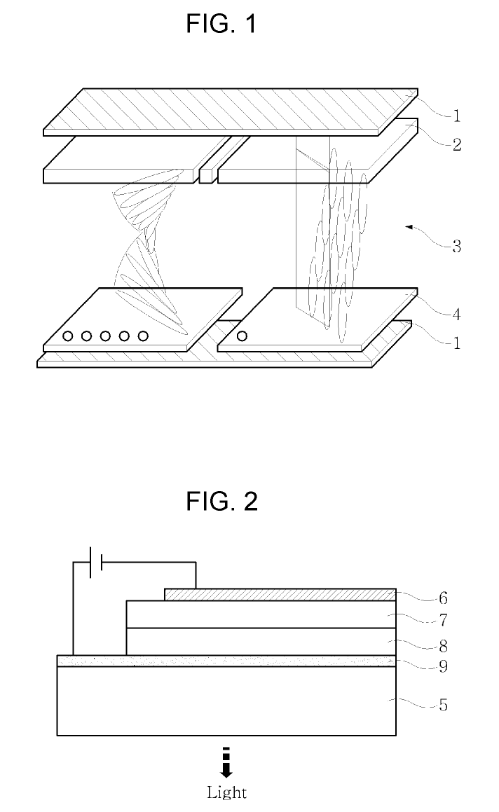

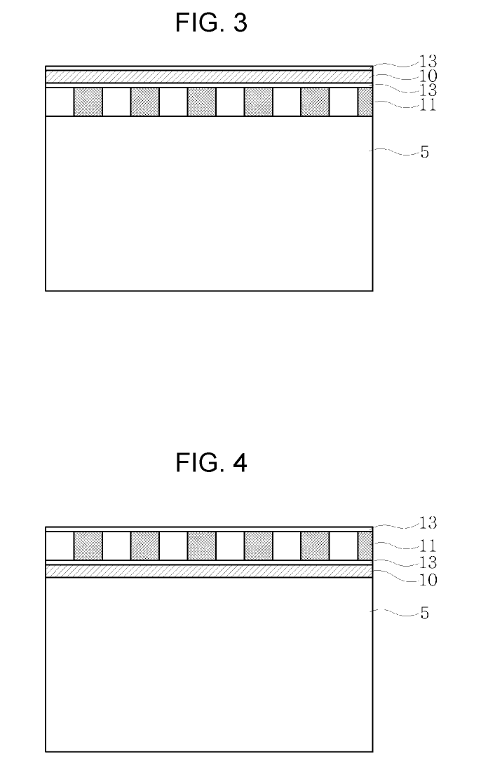

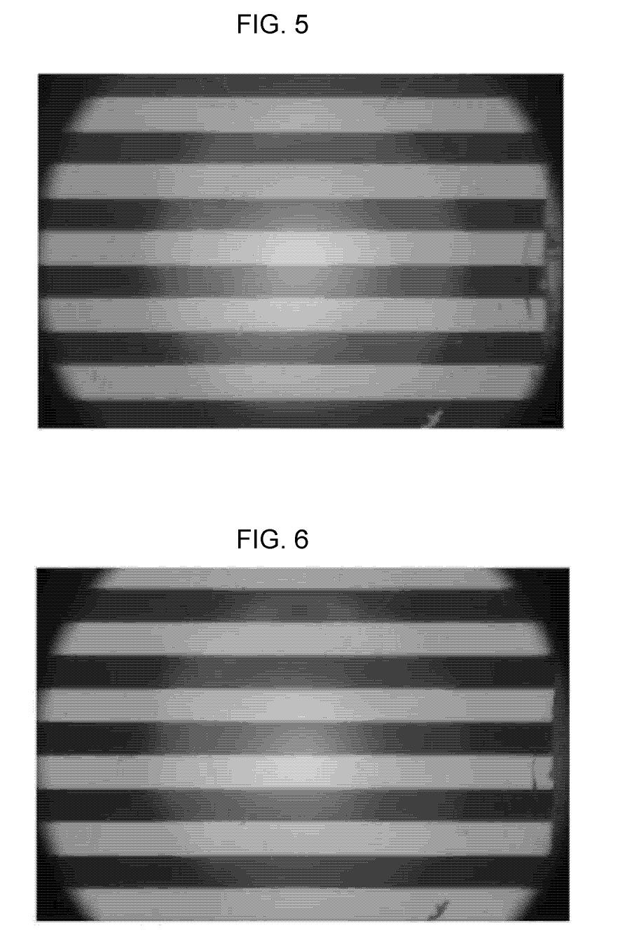

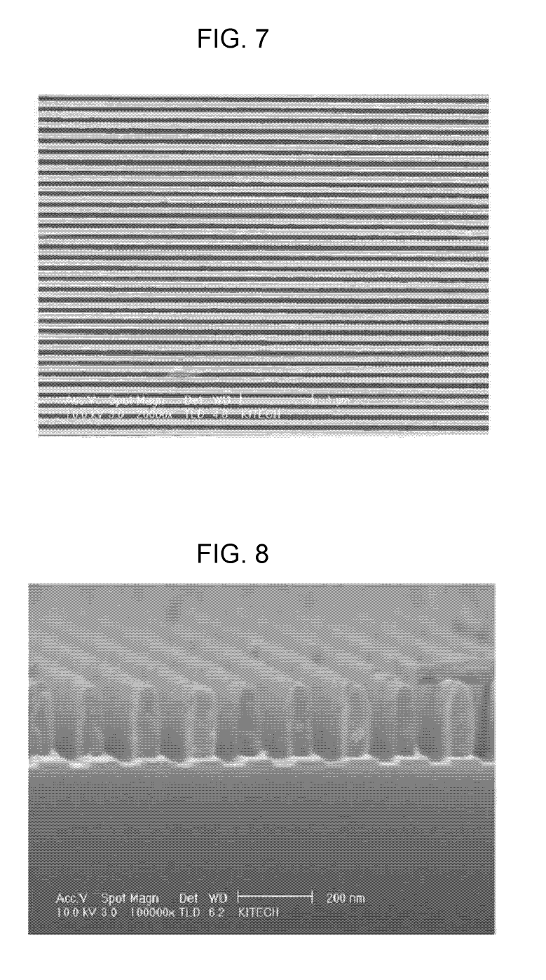

FIG. 1 is a view for describing a principle of a TFT-LCD (Thin Film Transistor Liquid Crystal Display), FIG. 2 is a view for describing a structure of an OLED and a light emitting principle, FIG. 3 is a view illustrating a structure according to a first embodiment of the present invention, FIG. 4 is a view illustrating a structure according to a second embodiment of the present invention, FIG. 5 is an image illustrating a state that a polarized light is observed by a left eye when a polarizer is used after the polarized light transmits a patterned retarder layer, FIG. 6 is an image illustrating a state that a polarized light is observed by a right eye when a polarizer is used after the polarized light passes a patterned retarder layer, FIG. 7 is a SEM image illustrating a plane of a patterned wire grid polarizer, and FIG. 8 is a SEM image illustrating a cross section of a patterned wire grid polarizer.

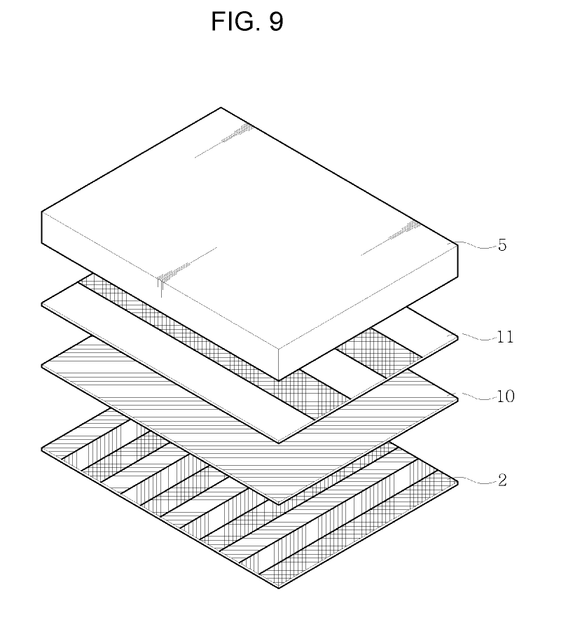

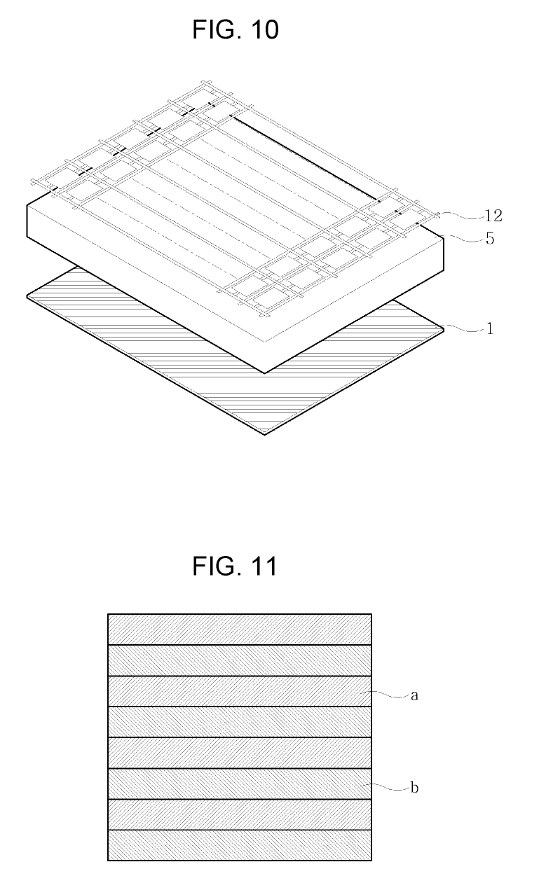

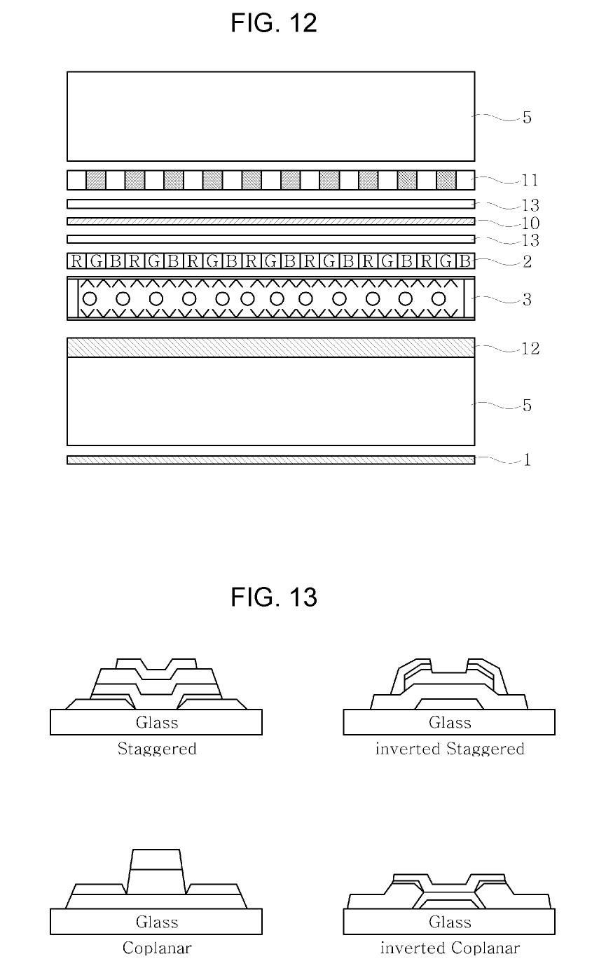

FIG. 9 is a view illustrating a structure that a patterned retarder and a wire grid polarizer are adapted to a color filter (C/F) of a TFT-LCD according to the present invention, FIG. 10 is a view illustrating a structure of a TFT glass substrate in which a TFT is formed, FIG. 11 is a view illustrating a state that a light passed through a patterned wire grid polarizer and λ/2 patterned retarder is linearly polarized, FIG. 12 is a view illustrating a structure according to a third embodiment of the present invention, and FIG. 13 is a view illustrating a basic structure of a TFT which is used for a TFT-LCD and an AMOLED.

FIG. 1 is a view illustrating a TFT-LCD. Here, the TFT is a switching device which uses an amorphous silicon as an active layer and is adapted to an active matrix liquid crystal display, a switching device of an electric light emitting device and a peripheral circuit. Generally, an active layer of a thin film transistor used as a switching device for driving a pixel electrode of a TFT-LCD is classified into an amorphous silicon (a-Si:H) and a poly silicon (poly-Si). Here, since the amorphous silicon can be used without a crystallizing process at a high temperature after it is deposited on a substrate, it has many advantages in view of a mass production and a large area LCD.

The TFT-LCD of FIG. 1 comprises a polarizing plate 1 disposed at both sides of upper and lower portions. A color filter 2, a liquid crystal 3 and an electrode 4 of a TFT pixel are sequentially stacked from the lower side of the polarizing plate 1 of the upper side.

FIG. 2 is a view for describing a structure of an OLED and a light emitting principle.

As shown therein, the OLED is stacked in a sequence of a cathode 6, an organic light emitting layer 7, a hole transport layer 8, an anode 9 and a glass substrate 5 from an upper side to a lower side. Electric power is connected between the cathode 6 and the anode 9. When electric power is supplied, light is downwardly emitted from the glass substrate 5.

FIG. 3 is a view illustrating a structure according to a first embodiment of the present invention.

As shown in FIG. 3, a patterned retarder 11 is formed on the glass substrate 5, and a layer of protective coating 13 is formed so as to protect the patterned retarder 111 during the following processes. A wire grid polarizer 10, which micro-patterns a formed metallic thin film, and a layer of protective coating 13 for protecting the wire grid polarizer 10 are sequentially formed. As shown in FIG. 12, the above resultant structure is adapted to a substrate of the color filter plate of the upper part of the TFT-LCD, so that a display can be obtained, which does not have any limitations to a visual distance or a visual angle.

As shown in FIG. 12, the light from a backlight transmits the polarizer 1, the TFT, the liquid crystal layer 3 and the color filter 2 and then transmits the wire grid polarizer 10 and becomes a linearly polarized light. The light transmits the patterned retarder 11. The patterned retarder 11 is implemented based on a principle that the phase contrast between the odd number row and the even number row is 90°. The linearly polarized light transmitted through the glass substrate 5, which corresponds to the odd number row and the even number row, are adapted to a certain structure such as glasses of left and right eyes, so that the images of the odd number row and the even number row are separated to left and right eyes and are combined by a brain, thereby implementing a three dimensional image.

FIG. 4 is a view illustrating a structure according to a second embodiment of the present invention.

As shown in FIG. 4, a wire grid polarizer 10, which micro-patterns a metallic thin film, and a layer of protective coating 13 for protecting the wire grid polarizer 10 are sequentially formed on a glass substrate 5. The patterned retarder 11 is formed, and the layer of protective coating 13 is formed for protecting the patterned retarder 11. FIG. 4 is a view illustrating a structure formed in a sequence reverse to the sequence of the structure of FIG. 3. The above structure is used for the TFT plate in the TFT-LCD structure, and a zigzag type polarizer is used for the substrate of the color filter corresponding to the upper plate, so that the display according to the present invention is obtained without any limitations to a visual distance and a visual angle.

FIG. 5 is an image illustrating a state that a polarized light is observed by a left eye when a polarizer is used after the polarized light passes a patterned retarder layer.

The image of FIG. 5 is obtained when, in a state that the patterned retarder 11 is positioned on the linear polarizer, the linearly polarized light (for example, when the light transmitting through the odd number row is a 45° linearly polarized light, it is possible to see the light by using a linearly polarized light having a 45° optical axis. However, since the even number row has light having an optical axis of 135° crossed at an angle of 90°, the image is seen in a black color since the light does not transmit the even number row) corresponding in parallel to an odd number row and an even number row is adapted to a structure such as glasses of left and right eyes, and the image is seen with one eye while covering its one side.

In the row seen bright in the image of FIG. 5, since the optical axis direction of the linearly polarized light and the optical axis direction of the linearly polarized light from the patterned retarder 11 are parallel with respect to each other, the light can be seen. On the contrary, in the dark row in which light cannot seem to transmit, the optical axis of the linearly polarized light and the optical axis direction of the linearly polarized light from the patterned retarder 11 are crossed at 90°, the light cannot be seen.

FIG. 6 is an image illustrating a state that a polarized light is observed by a right eye when a polarizer is used after the polarized light transmits a patterned retarder layer.

The image of FIG. 6 is seen when the linearly polarized light corresponding in parallel with respect to an odd number row and an even number row in a state that the patterned retarder 11 is positioned on the linear polarizer is adapted to a structure such as glasses of left and right eyes and is seen with one eye while covering its opposite side of FIG. 5.

In the image of FIG. 6, the bright row in which light transmits and the dark row in which light does not transmit are formed since the optical axis directions of the linearly polarized light of the odd number row and the even number row of the patterned retarder 11, as shown in FIG. 5, may be parallel with each other, so that the light can be seen, or may be crossed at 90°, so that the light cannot be seen.

FIG. 7 is a SEM image illustrating a plane of a patterned wire grid polarizer according to the present invention.

In the image of FIG. 7, a metallic thin film is formed on a glass substrate and is patterned using a micro patterning apparatus of a nano class for thereby forming a wire grid polarizer 10. Here, the wire grid polarizer 10 plays a role of the linear polarizer in the present invention.

FIG. 8 is a SEM image illustrating a cross section of a patterned wire grid polarizer according to the present invention.

In the cross section image of FIG. 8, the wire grid polarizer 10 may have a micro pattern of a sharp nano class when the wire grid pattern is formed.

FIG. 9 is a view illustrating a structure that the patterned retarder and the wire grid polarizer are adapted to a color filter (C/F) of the TFT-LCD according to the present invention.

As shown in FIG. 9, the patterned retarder 11 is formed on the glass substrate 5 like the method of FIG. 3, and then the layer of protective coating 13 is formed so as to protect the patterned retarder 11 from the following processes. The structure, in which the wire grid polarizer 10 formed by micro-patterning a metallic thin film and the layer of protective coating 13 for protecting the wire grid polarizer 10 are sequentially formed, is adapted to the color filter of the LCD. A common electrode and an alignment film are formed after the color filter is formed on the patterned retarder and the wire grid polarizer, and a resultant structure is adapted to the color filter substrate of the LCD. As shown in FIG. 3, it is possible to implement a three dimensional image by wearing linearly polarized light glasses corresponding to the odd number row and the even number row at the time when seeing the light which transmits the color filter, the wire grid polarizer and the patterned retarder, respectively.

FIG. 10 is a view illustrating a structure of a TFT glass substrate having a TFT according to the present invention.

As shown in FIG. 10, there is provided a cross section of the TFT substrate of the conventional LCD. The TFT and a polarizing plate 1 are attached on the glass substrate 5 through the TFT process. In the present invention, as shown in FIG. 9, since the patterned retarder and the wire grid polarizer are adapted to the color filter substrate, a conventional TFT glass substrate as well as all types of substrates, which use a low temperature process or a high temperature process, can be adapted. An alignment film is formed on the TFT glass substrate (FIG. 10) and is attached to the color filter glass substrate of FIG. 9, and liquid crystal is injected, and a bonding process is performed. With the above processes, a three dimensional image device can be obtained.

FIG. 11 is a view illustrating a state that a light passed through a patterned wire grid polarizer and λ/2 patterned retarder is linearly polarized.

As shown therein, light transmits the wire grid polarizer 10 and becomes a linearly polarized light, and the light transmits the λ/2 patterned retarder 11 and is linearly polarized at an angle of 90° with respect to the odd number row and the even number row, respectively. When linearly polarized light glasses corresponding in parallel to the light linearly polarized to the odd number row and the even number row, respectively, is worn (for example, when the light transmitting the odd number row is linearly polarized at an angle of 45°, it is possible to see the light by using the linearly polarizing plate having an optical axis of 45°, and when the light transmitting the even number row is linearly polarized at an angle of 135°, it is possible to see the light by using the linearly polarizing plate having an optical axis of 135°, it is possible to see linearly polarized light.

However, since the odd number row and the even number row are crossed with each other at 90°, in case of the linearly polarized light having an optical axis of 45°, it is possible to see the light having an optical axis of 45°, but when the light having an optical axis of 135° is seen with a linearly polarized light of an optical axis of 45°, it is crossed at an angle of 90°, so that it looks dark since the light does not transmit.

So, as shown in FIG. 11, the odd number row is recognized as a linearly polarizing plate having an optical axis being parallel with the odd number row, and the even number row is recognized as a linearly polarizing plate having an optical axis being parallel with the even number row. Consequently, only the odd number row can be seen with the linearly polarizing plate having an optical axis being parallel with the odd number row, and the even number row has an optical axis being crossed at an angle of 90° and looks dark. FIGS. 5 and 6 show the above phenomenon in the form of an optical image. FIG. 11 is a view illustrating a state that a light passed through a patterned wire grid polarizer and λ/2 patterned retarder is linearly polarized.

The patterned retarder layer, which uses a TFT and color filter (C/F), preferably has a retarder of λ/2 or λ/4. The retarder patterned on the glass substrate may form a linearly polarized light or a circularly polarized light based on λ/2 or λ/4.

Generally, when the light linearly polarized through the polarizing plate transmits the λ/2 phase contrast plate (retarder), the light becomes a linearly polarizing light changed at 90° as compared to the initially incident light. When the light linearly polarized through the polarizing plate transmits the λ/4 phase contrast plate (retarder), the light becomes a circularly polarized light.

In the present invention, the light linearly polarized through the wire grid polarizer transmits the λ/2 patterned retarder, so that it is possible to obtain a linearly polarized light having a polarizing direction in which the odd number row and the even number row are changed at an angle of 90° in the linearly polarized light in the pattern regions of the odd number row and the even number row of the patterned retarder.

In the present invention, when the λ/4 patterned retarder is used, the light linearly polarized through the wire grid polarizer transmits the λ/4 patterned retarder, so that the odd number row and the even number row of the linearly polarized light have left circular or right circular polarized lights in the pattern regions of the odd number row and the even number row of the patterned retarder.

FIG. 12 is a view illustrating a structure according to a third embodiment of the present invention.

In the embodiment of FIG. 12, a patterned retarder 11, a layer of protective coating 13, a micro pattern wire grid polarizer 10 having a polarizing function, a layer of protective coating 13, a color filter 2, a TFT 12, a glass substrate 5 and a polarizing plate 1 are sequentially stacked from the glass substrate 5 of the upper layer.

As shown in FIG. 12, there is provided a method for manufacturing a three dimensional display which comprises a step (a) in which a substrate having a patterned retarder is used or a patterned retarder is formed on a substrate, a step (b) in which a layer of protective coating is deposited on the patterned retarder substrate, a step (c) in which a formed metallic thin film is etched with a micro wire pattern, a step (d) in which a layer of protective coating is formed on the etched wire pattern, a step (e) in which a color filter is formed, and a cell step (f) in which a substrate having a color filter formed based on a wire grid polarizer put together with a substrate having a TFT and the patterned retarder substrate.

In the steps (b) and (d) related with FIG. 12, the layer of protective coating and insulator layer deposition method is preferably a PECVD (Plasma Enhanced Chemical Vapor Deposition) method. However, the above method is not limited thereto. Namely, it may be deposited by a CVD (Chemical Vapor Deposition) method, an evaporation method using a thermal decomposition, a sputtering method which uses an oxide film target or a printer or spin coating method.

The layer of protective coating may be formed of SiO₂, SiNₓ, SiON, a silicate film, an organic film, etc. It may be formed of a single film or may be formed of multiple films made by stacking homogenous films or heterogeneous films by at least two layers.

The metal of a metallic thin film of the step (b) may be selected among metals such as Al, Al alloy, Ni, Co, Pd, Pt, Fe, Cu, Ag, Au, In, Sn, As, Sb, MoW or among polymer or polarizing nano material (TCF). The metal may be formed of a single film or may be formed of multiple films made by stacking homogenous films or heterogeneous films by at least two layers.

The above elements may be provided in a form of alloy by including at least one element.

In the step for forming a color filter on the patterned retarder of the step (e), the conventional TFT-LCD processes may be directly used without an expensive equipment or apparatus.

FIG. 13 is a view illustrating a basic structure of a TFT which is used for a TFT-LCD, an AMOLED, etc.

Here, the TFT is classified into a staggered structure in which a gate electrode, a source electrode and a drain electrode are separated with respect to an active layer, and a coplanar structure in which a gate electrode, a source electrode and a drain electrode are formed on one surface of the active layer.

The staggered structure is classified into a thin film transistor in which a gate electrode is provided on an upper side of the active layer, and an inverted staggered structure in which a gate electrode is provided below the active layer.

When an amorphous silicon is used for a thin film transistor of a LCD, since the amorphous silicon is too sensitive to light, a leakage current of a thin film transistor increases. So as to lower a leakage current due to the light of a backlight, an inverted staggered structure is used, in which a gate electrode is provided below an active layer.

The inverted staggered structure will be described in more detail. A gate electrode is formed on a substrate. A gate insulator film is deposited on an upper side of a resultant structure. An amorphous silicon, which is an active layer, is stacked.

A source electrode and a drain electrode are formed on an upper side of the active layer, so that a thin film transistor of an inverted staggered structure is formed and is used as a switching device of the LCD.

In the case that an organic TFT is used, since an active layer is used as an organic semiconductor material, it is more preferable to use a thin film transistor of an inverted coplanar, in which an active layer is disposed at an upper side for thereby minimizing a damage of an organic semiconductor material, during a TFT process.

Since the patterned retarder substrate can be well adapted to a C/F process (in which about 130° temperature is used during cell bolding), it is possible to manufacture an excellent three dimensional display by using all kinds of TFT substrates such as a-Si:H TFT, poly-Si TFT, organic TFT, etc. irrespective of a TFT process which is performed at a low temperature as well as a TFT process which is performed at a high temperature.

The patterned retarder and wire grid polarizer method can be well adapted to a color filter (C/F) substrate of a TFT-LCD as well as a color filter (C/F) glass substrate and a TFT substrate since it can be adapted to a low temperature TFT process.

In addition, since the patterned retarder and the wire grid polarizer can be adapted to a glass substrate process as well as a process performed on a flexible plastic substrate, it is possible to implement a flexible three dimensional image display which will be commercialized in the future.

The patterned retarder and the wire grid polarizer can be well adapted to a display, which uses an AMOLED, a CNT type wire grid polarizer, and other flat panel displays (FPD) and can be adapted for a combined use of 2D/3D. In the present invention, it is possible to easily implement a high quality three dimensional display.

According to the manufacturing method of the present invention, the wire grid polarizer can be directly adapted to the patterned retarder glass substrate in the color filter (C/F) process as compared to conventional processes in which the module of the TFT-LCD is separated, and the patterned retarder is attached, so that the related processes and productivity are significantly enhanced. It is possible to basically prevent foreign substances such as dust or other pollutants from being inputted during the processes.

In addition, since the color filter (C/F) process is implemented by directly using a patterned retarder glass substrate, the large area display of a three dimensional image can be made, and it is possible to manufacture an excellent three dimensional image TFT-LCD by not using an expensive equipment and apparatus.

According to the present invention, it is possible to significantly improve the problems encountered in the module attaching and detaching processes when manufacturing a conventional three dimensional image display. The present invention can be directly adapted to a manufacture process of the current TFT-LCD without any problems.

With a simplified process of the present invention, the process cost is decreased. It is possible to significantly decrease the process pollution which occurs when attaching and detaching the modules during the manufacture of the conventional three dimensional image display, and the present invention can be well adapted to manufacturing a large area display.

The present invention may be provided with an optical structure in which a two dimensional image and a three dimensional image can be obtained.

Since the patterned retarder and the wire grid polarizer are formed in an optical structure disposed very close to the LCD, it is possible to achieve a three dimensional image irrespective of a viewing angle and a viewing distance in left and right directions, which are disadvantageously limited in the conventional three dimensional image display. So, the present invention can provide a next generation type 2D/3D—combined image display with many advantages.

The high quality three dimensional image display according to the present invention can be adapted to a display, which uses an AMOLED, CNT type wire grid polarizer and other flat panel displays (FPD) by using a patterned retarder and a wire grid polarizer, and it is possible to easily implement a three dimensional image.

In the present invention, a patterned retarder glass substrate can be directly used to a color filter (C/F) process, so that the processes and productivity are significantly enhanced as compared to conventional processes in which the module of the TFT-LCD is separated, and the patterned retarder is attached. It is possible to basically prevent dusts and other pollutants from being inputted during the process.

In the present invention, since the patterned retarder can be well adapted to an a-Si:H TFT process which uses a glass substrate as well as an a-Si:H TFT process on a flexibly plastic substrate by decreasing a temperature and an organic TFT process. It is possible to implement a flexible three dimensional image display.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a three dimensional image display formed of a TFT-LCD (Thin Film Transistor Liquid Crystal Display), a three dimensional image display, comprising:
a patterned retarder which is formed on an upper side of a glass substrate;
a layer of protective coating which is formed for protecting the patterned retarder from the subsequent processes;
a metallic thin film;
a wire grid polarizer which is formed by nano-patterning the metallic thin film; and
a layer of protective coating which is formed for protecting the wire grid polarizer,
wherein the above elements are sequentially formed.

2. The display of claim 1, wherein said patterned retarder and wire grid polarizer are formed on a substrate.

3. The display of claim 2, wherein said patterned retarder and wire grid polarizer substrate is applied to a color filter substrate of a TFT-LCD.

4. The display of claim 2, wherein said patterned retarder and wire grid polarizer are applied to a display, which uses an AMOLED or a CNT (Carbon Nano Tube) type wire grid polarizer, and other flat panel displays (FPD).

5. The display of claim 2, wherein said patterned retarder and wire grid polarizer are adapted on a TFT substrate in a low temperature TFT process.

6. The display of claim 3, wherein a formation of the patterned retarder and wire grid polarizer uses a structure for stacking on one surface of the substrate which will be used, and a patterned retarder is formed on one surface of the substrate which will be used, and a wire grid polarizer is formed on the other surface of the same.

7. A method for manufacturing a three dimensional display, comprising:
a step in which a substrate having a patterned retarder is used or a patterned retarder is formed on a substrate;
a step in which a layer of protective coating is deposited on the patterned retarder substrate;
a step in which a formed metallic thin film is etched with a nano pattern;
a step in which a protective coating is formed on the etched wire pattern;
a step in which a color filter is formed; and
a cell step in which a substrate having a color filter formed based on a wire grid polarizer process is put together with a substrate having a TFT and the patterned retarder substrate.

8. The method of claim 7, wherein in said step for using a substrate having a patterned retarder or forming a patterned retarder on the substrate, the substrate is formed in such a manner that a patterned retarder is formed on a transparent substrate including glass and plastic or a substrate is formed in such a manner that a patterned retarder is attached to the substrate.

9. The method of claim 7, wherein in said step for using a substrate having a patterned retarder or forming a patterned retarder on the substrate, the step for forming the patterned retarder and the wire grid polarizer comprises a step for forming a wire grid polarizer after the patterned retarder is formed on a glass substrate, and a step for forming a patterned retarder after a wire grid polarizer is formed on a glass substrate.

10. The method of claim 8, wherein a thickness of a patterned retarder formed on the substrate is a few μm or less than the same.

11. The method of claim 7, wherein in said step for depositing a layer of protective coating on the patterned retarder substrate and then forming a metallic thin film, a metallic thin film is formed by one of the methods selected among an evaporation method using a thermal decomposition, a sputtering method using a metallic film target, and an e-beam evaporation method (e-beam deposition).

12. The method of claim 7, wherein in said step for forming a metallic thin film after a protective coating layer is formed on the patterned retarder substrate, a protective coating layer is formed before a metallic thin film is formed, whereby preventing a damage of a patterned retarder which may occur when a metallic thin film is etched.

13. The method of claim 7, wherein in said step for etching a metallic thin film in a nano wire pattern, a selective etching process is applied to a wire structure pattern by one method selected among a photolithography method, a photoresister method, a shadow mask method and an imprint lithography method.

14. The method of claim 7, wherein in said step for forming a layer of protective coating on the etched wire pattern, an insulator layer is formed by one method selected among a PECVD (Plasma Enhanced Chemical Vapor Deposition) method, a CVD (Chemical Vapor Deposition) method, an evaporation method using a thermal decomposition, a sputtering method using an oxide film target and a printer or spin coating method.

15. The method of claim 7, wherein in said step for forming a color filter, a color filter process is performed on a substrate on which a patterned retarder and a wire grid polarizer are formed.

16. The method of claim 7, wherein in said cell step for putting together a substrate having a color filter adapted with a wire grid polarizer process, with the substrate having the TFT and the patterned retarder substrate, a substrate having a color filter formed through a wire grid polarizer process is formed on the substrate having the TFT and the patterned retarder substrate, respectively.

17. The method of claim 7, wherein in said step for forming a layer of protective coating on the patterned retarder substrate and forming a metallic thin film, the thickness of the metallic thin film is 10˜10000 Å.

18. The method of claim 7, wherein in said step for forming a layer of protective coating on the patterned retarder substrate and forming a metallic thin film, the metallic thin film is selected among metals such as Al, Al alloy, Ni, Co, Pd, Pt, Fe, Cu, Ag, Au, In, Sn, As, Sb, MoW or among polymer or polarizing nano material (TCF), and said metallic thin film is formed of a single film or is formed of multiple films made by stacking homogenous films or heterogeneous films by at least two layers.

19. The method of claim 7, wherein in said step for forming a layer of protective coating on the patterned retarder substrate and forming a metallic thin film and in said step for forming a layer of protective coating on the etched wire pattern, the thickness of the insulator layer and the layer of protective coating are 10˜10000 Å.

20. The method of claim 7, wherein in said step for using a substrate having a patterned retarder or forming a patterned retarder on the substrate, the patterned retarder uses a linearly polarized light when the patterned retarder is λ/2, and it uses a circular polarized light when the patterned retarder is λ/4 for thereby separating an odd number row and an even number row, so that a combination of images separated to the left and right eyes are recognized as a three dimensional image based on the above operation.

21. The method of claim 7, wherein in said step for forming a layer of protective coating on the patterned retarder substrate and forming a metallic thin film and in said step for etching a metallic thin film in a nano wire pattern, the metallic thin film formation and micro wire pattern are implemented by using a CNT.

22. The method of claim 19, wherein said insulator layer is formed by using a silicon oxide film, a silicon nitride film, a silicon oxide nitride film, a silicate film and an organic film or is formed of a single film or is formed of multiple films by stacking a homogeneous thin film or heterogeneous thin films by at least two layers.

23. The method of claim 20, wherein said patterned retarder is formed of a retarder in which the patterned retarder is λ/2 patterned and is formed of a retarder in which the patterned retarder is λ/4 patterned.
